(19) United States
(12) Patent Application Publication
(10) Pub. No.: US 2006/0272456 A1
(43) Pub. Date: Dec. 7, 2006

(54) Spanner with teeth section at clamp portion

(76) Inventor: Chih-Ching Hsien, Tai-Chung Hsien (TW)

Correspondence Address: Chih-Ching Hsien, 235 Chung-Ho, Box 8-24, Taipei, TW

(21) Appl. No.: 11/146,261

(22) Filed: Jun. 7, 2005

(51) Int. Cl. B25B 13/00; B25B 13/02

(52) U.S. Cl. 81/119; 81/186

(57) ABSTRACT

A spanner with a teeth section at a clamp portion has a spanner body. The spanner body includes a holding portion and a driving head which is connected to one end of the holding portion; the driving head having a first jaw and a second jaw; an inner surfaces of the first jaw and the second jaw being driving surfaces; the driving surface of the first jaw being formed with a teeth section; a rearmost tooth of the teeth section near the rear end of the first jaw being a protecting tooth with a larger size than other teeth of the teeth section. The driving surface of the second jaw may have a teeth section as the first jaw or the driving surface of the second jaw being formed with a rib section; the rib section having a smooth side facing the first jaw.

### FIELD OF THE INVENTION

The present invention relates to spanners, and in particular to a spanner with at least one teeth section at a clamp portion which can provides a strong clamp force to the screw means clamped to the spanner and can protect the screw means not to wear at the apexes.

### BACKGROUND OF THE INVENTION

It is often that the screw means are worn at the apexes to have cambered shape as driving by spanner. Thereby pliers are used to drive the screw means. However the operation is inconvenient.

To improve above defect, in the U.S. Pat. No. 5,074,171, a spanner has two jaws which are approximately parallel to each other. Each jaw has as teethed driving surface. A length of the driving surface is smaller than that of a lateral side of a screw means so as to increase the clamping force of the spanner to a clamped object so that the object will not slide in operation. However this prior art spanner possibly destroys the screw means due to the teeth in the teeth section. Thereby for screw means with round apexes, it is difficult to fix the screw means and thus the operation is difficult.

In another improvement, U.S. Pat. No. 5,996,449, invented and assigned to the inventor of the present invention, where an improved spanner is disclosed, the inner surface of each jaw has a teeth section. Each tooth in the teeth section has a cambered apex. However although this prior art can improve some defects in the prior art, it is found that the clamping force of this spanner is not so strong. As the screw means to be driven is tightly engaged to an object, it is very difficult to release it.

### SUMMARY OF THE INVENTION

Accordingly, the primary object of the present invention is to provide a spanner with at least one teeth section at a clamp portion which can provides a strong clamp force to the screw means clamped to the spanner and can protect the screw means not to wear at the apexes.

To achieve above objects, the present invention provides a spanner with at least one teeth section at a clamp portion which comprises a spanner body. The spanner body includes a holding portion and a driving head which is connected to one end of the holding portion; the driving head having a first jaw and a second jaw; an inner surfaces of the first jaw and the second jaw being driving surfaces; the driving surface of the first jaw being formed with a teeth section; a rearmost tooth of the teeth section near the rear end of the first jaw being a protecting tooth with a larger size than other teeth of the teeth section. The driving surface of the second jaw may have a teeth section as the first jaw or the driving surface of the second jaw being formed with a rib section; and the rib section having a smooth side facing the first jaw.

The various objects and advantages of the present invention will be more readily understood from the following detailed description when read in conjunction with the appended drawing.

### BRIEF DESCRIPTION OF THE DRAWINGS

FIG. 1 is a schematic perspective view of the first embodiment of present invention.

FIG. 2 is a lateral view of the first embodiment of present invention.

FIG. 3 is a schematic view of another embodiment of the present invention.

FIG. 4 shows the use of the second embodiment of the present invention.

FIGS. 5, 6 and 7 shows the third embodiment of the present invention.

### DETAILED DESCRIPTION OF THE INVENTION

In order that those skilled in the art can further understand the present invention, a description will be described in the following in details. However, these descriptions and the appended drawings are only used to cause those skilled in the art to understand the objects, features, and characteristics of the present invention, but not to be used to confine the scope and spirit of the present invention defined in the appended claims.

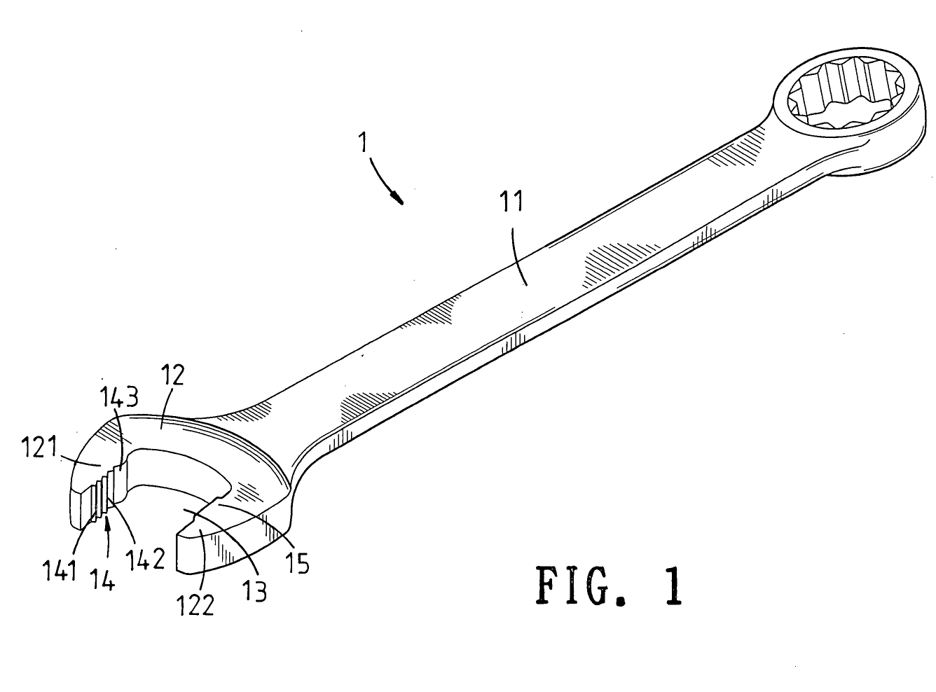

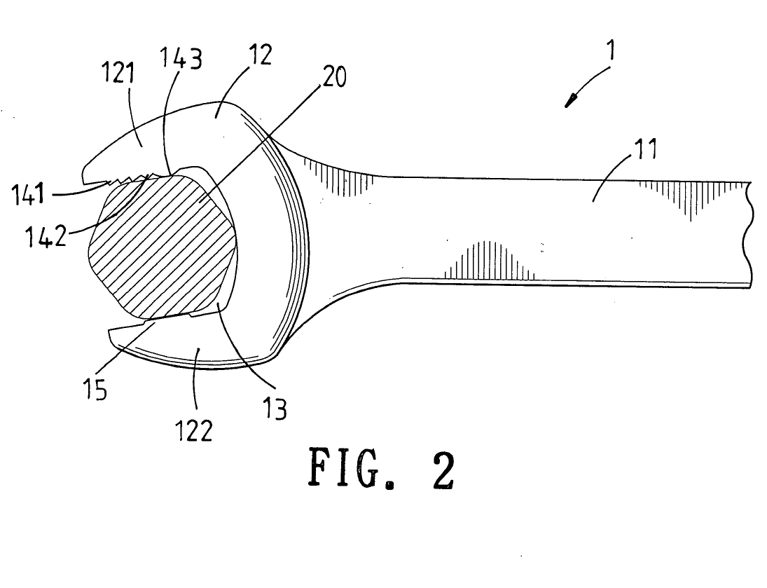

With reference to FIGS. 1 and 2, the present invention has the following elements.

A spanner body 1 includes a holding portion 11 and a driving head 12 which is connected to one end of the holding portion 11. The driving head 12 has a first jaw 121 and a second jaw 122. An inner surface of a front end of the first jaw 121 is parallel to an inner surface of a front end of the second jaw 122. A rear end of the first jaw 121 is connected to a rear end of the second jaw 122 so as to form a driving section 13 of the screw means 20.

The inner surfaces of the first jaw 121 and the second jaw 122 are as driving surfaces. The driving surface of the first jaw 121 is formed with a teeth section 14 for providing a greater clamping force as driving a screw means and reducing the slidness of the screw means. Referring to FIG. 2, a rearmost tooth of the teeth section 14 near the rear end of the first jaw 121 is a protecting tooth 143 with a larger size than other teeth of the teeth section 14. The protecting tooth 143 has a cambered apex so that when driving a screw means 20 to rotate, the screw means 20 will not be worn so have a round shape. The tooth 142 adjacent to the protecting tooth 143 has a shape of equilateral triangle and the other teeth of the teeth section 14 is as an un-equilateral triangular 141.

The driving surface of the second jaw 122 is formed with a rib section 15. A length of the rib section 15 is shorter than a length of one lateral side of the screw means 20 so as to protect the screw means 20 as driving the screw means 20. The rib section has a smooth side facing the first jaw 121.

Thereby by the present invention, the screw means 20 can be prevent from rounding the apexes of the screw means 20. If the screw means 20 has rounded apexes, the present invention will provide proper clamp force to the screw means 20.

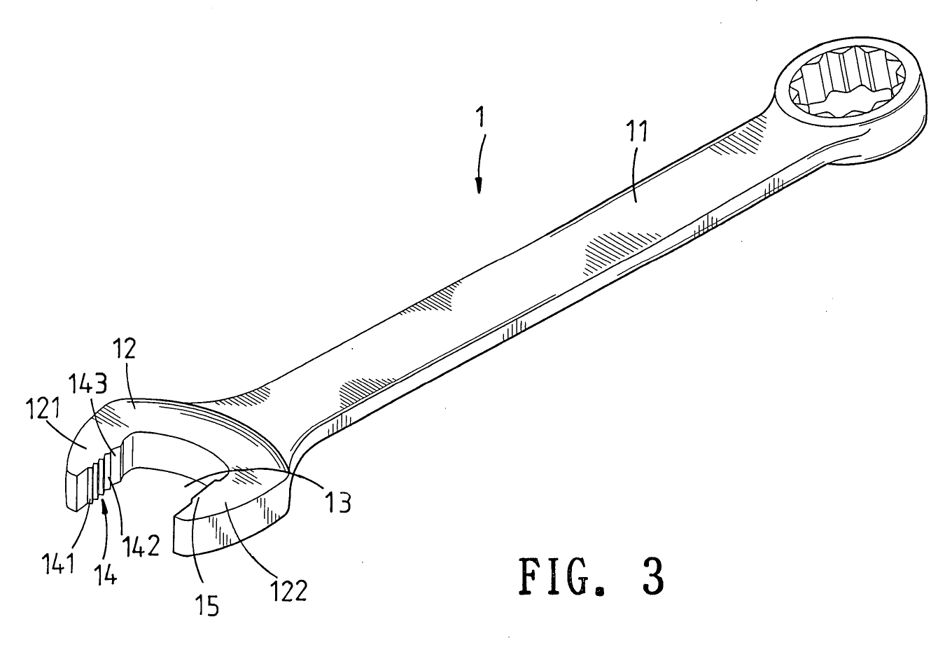

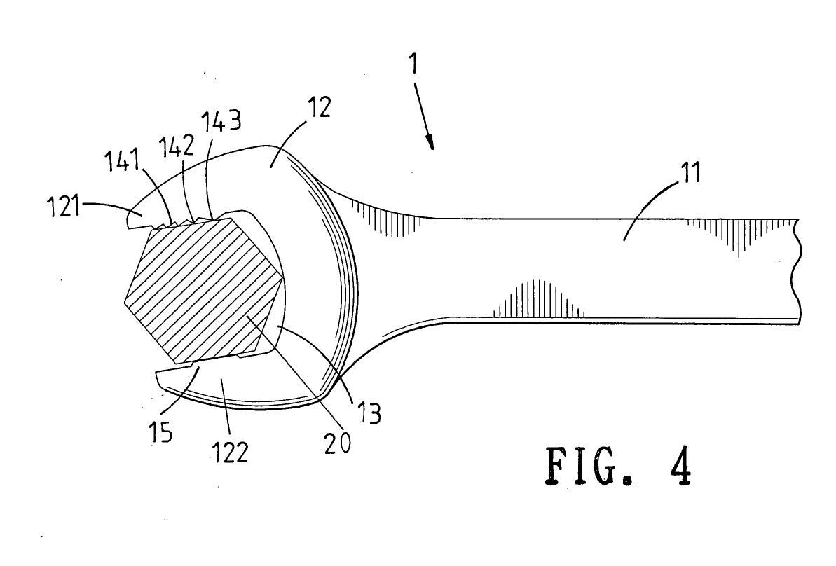

Referring to FIGS. 3 and 4, the second embodiment of the present invention will be described. Those identical to the first embodiment will not be described here. Only those different between the two are described. In this embodiment, the protecting tooth 143 is a sharp apex instead of a round apex.

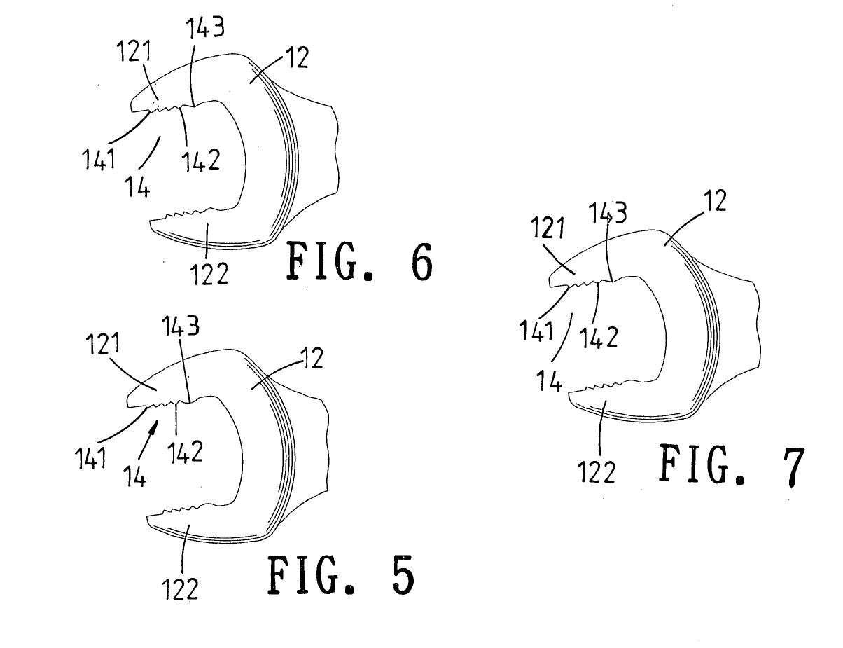

Referring to FIGS. 5 and 6, the second embodiment of the present invention will be described. Those identical to the first embodiment will not be described here. Only those different between the two are described. In this the present invention, the second jaw 122 also has a teeth section which is identical to the teeth section 14 of the first jaw 121. In FIG. 5, it is illustrated that the protecting teeth of the teeth sections of the first jaw 121 and second jaw 122 have round apexes. In FIG. 6, it is illustrated that the protecting teeth of the teeth sections of the first jaw 121 and second jaw 122 have sharp tip apexes. In FIG. 7, it is illustrated that the teeth section of the second jaw 122 is not identical to the teeth section 14 of the first jaw 121. In this embodiment, the protecting tooth 143 of the first jaw 121 has a sharp apex and that of the second jaw 122 has a round apex.

Furthermore, in any of the embodiment, it may be that some teeth of the teeth sections other than the protecting tooth have a shape of equilateral triangle and the other teeth of the teeth section have a shape of an un-equilateral triangular.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A spanner with a teeth section at a clamp portion; the spanner comprising a spanner body including a holding portion and a driving head which is connected to one end of the holding portion;
the driving head having a first jaw and a second jaw; an inner surface of a front end the first jaw being approximately parallel to an inner surface of a front end of the second jaw; a rear end of the first jaw being connected to a rear end of the second jaw so as to form a driving section of the screw means;
an inner surfaces of the first jaw and the second jaw being as driving surfaces; the driving surface of the first jaw being formed with a teeth section; a rearmost tooth of the teeth section near the rear end of the first jaw being a protecting tooth with a larger size than other teeth of the teeth section; and
the driving surface of the second jaw being formed with a rib section; and the rib section having a smooth side facing the first jaw.

2. The spanner with a teeth section at a clamp portion as claimed in claim 1, wherein a length of the rib section is shorter than a length of one lateral side of a screw means.

3. The spanner with a teeth section at a clamp portion as claimed in claim 1, wherein the protecting tooth has a cambered apex.

4. The spanner with a teeth section at a clamp portion as claimed in claim 1, wherein the protecting tooth has a sharp apex.

5. The spanner with a teeth section at a clamp portion as claimed in claim 1, wherein a tooth adjacent to the protecting tooth has a shape of equilateral triangle and the other teeth of the teeth section have a shape of an un-equilateral triangular.

6. The spanner with a teeth section at a clamp portion as claimed in claim 3, wherein a tooth adjacent to the protecting tooth has a shape of equilateral triangle and the other teeth of the teeth section have a shape of an un-equilateral triangular.

7. The spanner with a teeth section at a clamp portion as claimed in claim 4, wherein a tooth adjacent to the protecting tooth has a shape of equilateral triangle and the other teeth of the teeth section have a shape of an un-equilateral triangular.

8. The spanner with a teeth section at a clamp portion as claimed in claim 1, wherein some teeth of the teeth section other than the protecting tooth have a shape of equilateral triangle and the other teeth of the teeth section have a shape of an un-equilateral triangular.

9. A spanner with teeth sections at a clamp portion; the spanner comprising a spanner body including a holding portion and a driving head which is connected to one end of the holding portion;
the driving head having a first jaw and a second jaw; an inner surface of a front end of the first jaw being parallel to an inner surface of a front end of the second jaw; a rear end of the first jaw being connected to a rear end of the second jaw so as to form a driving section of the screw means; and
an inner surfaces of the first jaw and the second jaw being driving surfaces;
each of the driving surfaces of the first jaw and the second jaw being formed with a teeth section; a rearmost tooth of each teeth section near the rear end of the first jaw or the second jaw being a protecting tooth with a larger size than other teeth of the teeth section; and

10. The spanner with teeth sections at a clamp portion as claimed in claim 9, wherein each of the protecting teeth of the first jaw and the second jaw has a round apex.

11. The spanner with teeth sections at a clamp portion as claimed in claim 9, wherein each of the protecting teeth of the first jaw and second jaw has a sharp apex.

12. The spanner with teeth sections at a clamp portion as claimed in claim 9, wherein the protecting tooth of the first jaw has a sharp apex and the protecting tooth of the second jaw has a round apex.

13. The spanner with a teeth section at a clamp portion as claimed in claim 9, wherein some teeth of the teeth sections other than the protecting tooth have a shape of equilateral triangle and the other teeth of the teeth section have a shape of an un-equilateral triangular.
